(19) United States
(12) Patent Application Publication
(10) Pub. No.: US 2025/0294359 A1
(43) Pub. Date: Sep. 18, 2025

(54) SECURITY IN RADIO ACCESS NETWORKS

(71) Applicant: Cirrus360 LLC, Richardson, TX (US)

(72) Inventors: Alan Gatherer, Dallas, TX (US); Chaitali Sengupta, Richardson, TX (US); Sudipta Sen, Richardson, TX (US)

(21) Appl. No.: 19/078,927

(22) Filed: Mar. 13, 2025

Related U.S. Application Data
(60) Provisional application No. 63/564,772, filed on Mar. 13, 2024.

(51) Int. Cl. H04W 12/106; H04W 12/122

(52) U.S. Cl. CPC H04W 12/106; H04W 12/122

(57) ABSTRACT

A method for enforcing security of radio access networks (RANs) is provided. The method includes running code in a secured middleware that can manipulate unit functions that process data. The method includes receiving data flows from one or more devices associated with the RAN, wherein the data flows are maintained in a first data space. The method includes validating the data flows based on security constraints. The method further includes executing stateless functions according to a configuration file of the middleware, wherein the configuration file is maintained independently from other data stored by the middleware. The method further includes updating a state of the RAN based on analysis results of the data validation and execution of the stateless functions.

### CROSS-REFERENCE TO RELATED APPLICATIONS

The present disclosure is related and claims priority, under 35 U.S.C. § 119(e), to U.S. Provisional Patent Application No. 63/564,772, entitled SECURITY IN RADIO ACCESS NETWORKS to Alan Gatherer, et-al., filed on Mar. 13, 2024, the contents of which are hereby incorporated by reference in its entirety, for all purposes.

### TECHNICAL FIELD

The present disclosure generally relates to a layered approach to enforcing security in Radio Access Networks (RANs). More specifically, the present disclosure is directed to manage the production of secure and optimized RAN code using Domain Specific Language (DSL) along with automation to guarantee security and resilience of developments in telecommunication systems.

### SUMMARY

The present disclosure is directed to systems, methods, and machine-readable media for enforcing security of radio access networks (RANs). The method includes running code through a security layer structure in a secured middleware that can manipulate unit functions that process data and is designed to be state space independent of the data it is processing. In this manner, malicious attackers are prevented from inserting invalid data and causing a state space change at the middleware level.

According to one embodiment of the present disclosure, a computer-implemented method for implementing security in a network development is provided. The method includes receiving data packets from one or more network devices in a RAN. The method also includes analyzing the data packets based on a set of constraints and functions of the RAN, the analysis including validating, in a first data space, the data packets based on a set of constraints, and executing, in a second data space, stateless functions of the RAN using the validated data packets based on configuration files. The method also includes updating a state of the RAN based on results of the analysis.

According to one embodiment of the present disclosure, a system is provided including a processor and a memory comprising instructions stored thereon, which when executed by the processor, causes the processor to perform a method for implementing security in a network development. The method includes receiving data packets from one or more network devices in a RAN. The method also includes analyzing the data packets based on a set of constraints and functions of the RAN, the analysis including validating, in a first data space, the data packets based on a set of constraints, and executing, in a second data space, stateless functions of the RAN using the validated data packets based on configuration files. The method also includes updating a state of the RAN based on results of the analysis.

According to one embodiment of the present disclosure, a non-transitory computer-readable storage medium is provided including instructions (e.g., stored sequences of instructions) that, when executed by a processor, cause the processor to perform a method for implementing security in a network development. The method includes receiving data packets from one or more network devices in a RAN. The method also includes analyzing the data packets based on a set of constraints and functions of the RAN, the analysis including validating, in a first data space, the data packets based on a set of constraints, and executing, in a second data space, stateless functions of the RAN using the validated data packets based on configuration files. The method also includes updating a state of the RAN based on results of the analysis.

According to one embodiment of the present disclosure, a system is provided that includes means for storing instructions, and means for executing the stored instructions that, when executed by the means, cause the means to perform a method for implementing security in a network development. The method includes receiving data packets from one or more network devices in a RAN. The method also includes analyzing the data packets based on a set of constraints and functions of the RAN, the analysis including validating, in a first data space, the data packets based on a set of constraints, and executing, in a second data space, stateless functions of the RAN using the validated data packets based on configuration files. The method also includes updating a state of the RAN based on results of the analysis.

These and other embodiments will be evident from the present disclosure. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BACKGROUND

With the exponential growth in wireless communication and the advent of technologies such as 5G and beyond, the complexity and scope of Radio Access Networks (RANs) have increased significantly, introducing new and evolving security challenges. RAN security is a critical aspect of ensuring the safety and integrity of networks and wireless communication between devices of the network. Ensuring robust security measures remains a top priority in the telecommunication industry to safeguard against, for example, cyber risks, hijacking, or the like. Therefore, there is a pressing need in the telecommunication industry for improved security measures in RAN development.

### BRIEF DESCRIPTION OF THE DRAWINGS

To easily identify the discussion of any particular element or act, the most significant digit or digits in a reference number refer to the figure number in which that element is first introduced.

FIG. 1 illustrates a network architecture used for implementing RAN security techniques, as described herein.

FIG. 2 is a block diagram illustrating details of devices used in the architecture, according to certain aspects of the present disclosure.

FIG. 3 is an example illustration of middleware employing a layered security framework in a system, according to certain aspects of the present disclosure.

FIG. 4 is an exemplary block diagram modelling a checking process in a modem architecture in a communication network, according to certain aspects of the present disclosure.

FIG. 5 illustrates an example flow diagram for implementing layered security in a RAN deployment, according to certain aspects of the present disclosure.

FIG. 6 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Open RAN deployments represent a Radio Access Network (RAN) standard that defines interfaces enabling interoperability between equipment from different vendors. Open RAN technology has been proposed as a solution to enhance network security by fostering a diverse ecosystem of equipment and software vendors for cellular infrastructure. However, the assumption that open RAN is inherently more secure relies on the belief that all individuals and companies involved will act in good faith, which is an unrealistic expectation. Moreover, many security breaches are caused by external attackers, not insiders. In this regard, open RAN may be more vulnerable to such attacks than traditional custom deployments.

Open RAN solutions are based on general purpose computer architectures with accelerators which offload computationally intensive processing tasks from a general-purpose hardware or CPU. The accelerators are programmed to run code associated with the tasks which is open to the general-purpose hardware programming errors that lead to security breaches. These solutions also use opportunistic scheduling making them more dangerous because they have a much larger state space than necessary, leading to numerous potentially invalid execution paths that may not result in a good solution.

Additionally, with the growing adoption of commercial off-the-shelf (COTS) hardware and open-source software in Open RAN, attacks targeting both RAN hardware and software have become a critical concern. Furthermore, as Open RAN introduces additional components and interfaces, the attack surface expands significantly. Such attacks—including hijacking, the introduction of compromised code, and resource exhaustion—can result in denial-of-service incidents and other malicious consequences. Compromised subroutines within RAN software or malicious runtime configuration changes due to unauthorized interactions further expose the infrastructure to security vulnerabilities. The approach taken in conventional open RAN systems is to provide an outer layer of protocol security protection (i.e., a “coconut” approach), followed by security testing and patching of hardware/software vulnerabilities. This approach impedes the system developer from expeditiously implementing the complex, required functionality needed for a market-competitive modem. Further, once the outer layer of security is breached, bad actors can dominate the RAN.

The code on a RAN is traditionally extremely generic because it is developed for a large set of possible configurations. As RAN technology has evolved from 2G to 5G, the complexity has increased, leading to more unintentional errors (e.g., Heisenbugs) and complicated field testing. With the advent of Open RAN, new security risks have emerged, allowing hackers to exploit untested behaviors in the RAN software through the enhanced Common Public Radio Interface (eCPRI) protocol. This can lead to failures in algorithms, overflows, and control code issues, ultimately enabling hackers to, e.g., take control of the RAN, maliciously configure the RAN at runtime, and/or execute man-in-the-middle (MITM) attacks from RU to DU.

For example, the method of entry for the hacker to install malicious code could be through manipulation of the eCPRI protocol. Incorrect protocol data transmitted from a handset becomes effectively code operating inside of the modem/DU by perturbing the complex RAN radio decode software in ways that it was never tested for, leading to failure in algorithms, overflows in FIFOs, and invalid branches in control code. This untested behavior can all be exploited to take control of the RAN itself. The RAN software in the DU that processes and decodes the radio waveform can be viewed as a parser of data input that, when shown invalid input, can stray into state space in which the hacker can exploit the system. As such, there is a need for improved security measures in RAN development to address these unique challenges.

Embodiments of the present disclosure address the above identified problems to provide systems and methods enabling secure RAN architectures using a layered approach to security in an automation framework. The layered approach uses Domain Specific Language (DSL) to manage the production of secure and optimized RAN code along with automation to guarantee security and resilience of developments in telecommunication systems. DSLs are specialized programming languages tailored for specific domains or tasks. They allow precise expression of requirements, policies, and configurations, enhancing automation and manageability. The DSL along with automation tooling enables the efficient composition of secure patterns-of-use. The proposed system uses automation and DSL methods to create more efficient and targeted solutions, making RAN development more secure and specialized. Hackers often use disruption of data structures, which represent the system's state, to gain a beachhead in RANs. The development and maturation of a DSL and pattern-based approach to RAN implementation and maintenance gives customers, privileged users authorized to interact with the network, system administrator, or the like, (hereafter collectively referred to as “users”) developing and deploying 5G networks a platform to ensure secure enablement of RAN networks from their suppliers by enforcing secure implementations in an auditable environment while still allowing and increasing the innovation and competition from diverse vendors.

Embodiments propose generating a secure system by separating operations (e.g., data movement and formatting operations of the modem are separated from compute operations). The compute operations are locked down in a requirement-specific manner in the center of the secure system. In this manner, security strategies, according to the layered security structure of embodiments, harden as you go deeper into the functionality of a RAN. According to embodiments, each of the security layers may implement formal checking procedures to identify and eradicate potential attack surfaces of the RAN. Following the layered approach, detection of violations in upper layers can be detected and eventually removed by inner layers of security.

According to embodiments, the layered approach may include running a control loop of the code from a highly secured middleware kernel (e.g., Service Abstraction Boundary Middleware (SABM)) with improved testing. The middleware may trigger RAN functions in a statically timed manner and detect errors in function output by flagging the output errors immediately based on functional correctness and timing of the output. The middleware may be configured to manipulate unit functions that process data. According to embodiments, the middleware is designed to be state space independent of the data it is processing so that the data read and written cannot change the ordering or the timing of future functions. In some implementations, the middleware may change the ordering or timing of future functions in a controlled and predefined manner that has already been analyzed to be secure. In this way, no bad actor can insert invalid data and cause a state space change at the middleware level.

The disclosed secure system addresses security issues in network equipment technology related to computer technology, specifically targeting technical problems associated with security in network equipment and deployments. The layered approach improves the technology and the functioning of computer networks by reducing the attack surface of the RAN and expediting the rollout of open RAN systems in 5G. The secure RAN architecture including the layered structure along with the automation framework is also equipped with the agility needed to adapt to custom requirements in specific market segments (e.g., in commercial telecommunications, enterprise, defense sectors, etc.) by using DSL and the automation framework. Further, the secure RAN architecture has lower control code complexity as it is use-case specific and static-simplifying RAN development while minimizing the probability of Heisenbugs.

Several implementations are discussed below in more detail in reference to the figures.

### Example Architecture

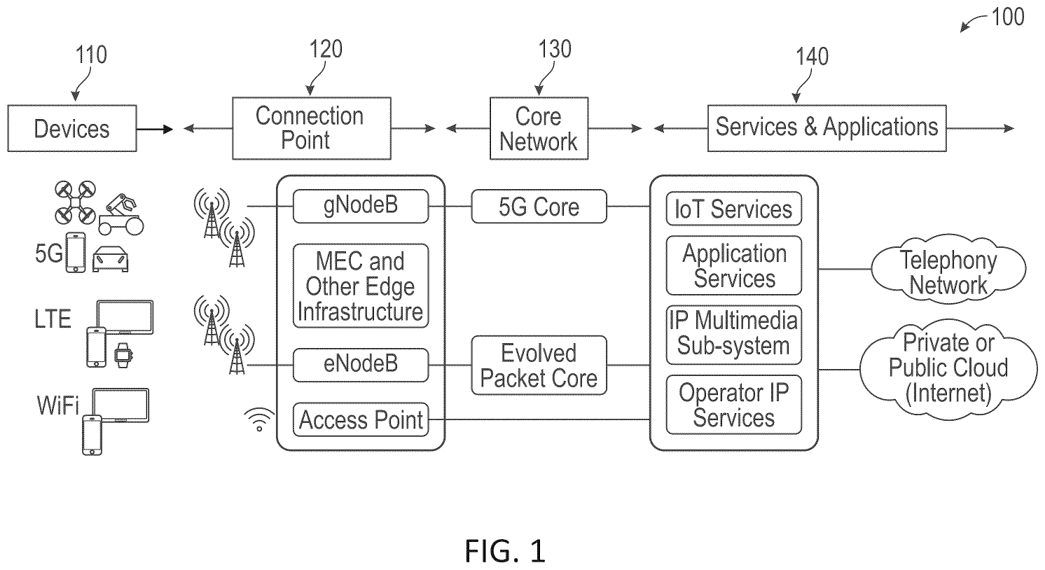

FIG. 1 illustrates an exemplary telecommunications infrastructure 100, according to certain aspects of the present disclosure. The telecommunications infrastructure 100 may include multiple devices 110 communicatively coupled to a connection point 120. For example, the devices 110 may include 5G/LTE/Wi-Fi/IoT enabled devices including, but not limited to, drones, smart cars, smart phones, smart televisions, smart watches, other smart devices, and the like. In an implementation, the connection point 120 may include, for example, RAN, ORAN, 5G, Wi-Fi, gNodeBs, eNodeBs, Multi-Access Edge Computing (MEC) and other edge infrastructures, access points, and the like.

The connection point 120 may be communicatively coupled to a core network 130. For example, the core network 130 may include a 5G core network, an evolved packet core network, and the like. The core network 130 may be communicatively coupled to multiple services and applications 140. For example, the services and applications 140 may be housed on various internet servers for IoT services, applications, IP multimedia sub-systems, operator IP services, and the like. The servers may be coupled to a telephone network, private or public cloud, the Internet, etc.

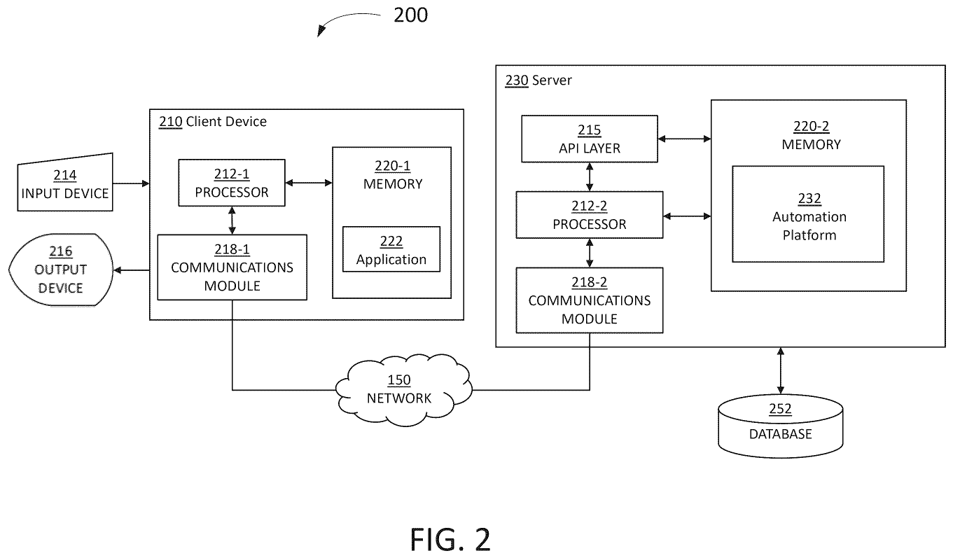

FIG. 2 is a block diagram 200 illustrating details of a client device 210 and a server 230 used in a network architecture as disclosed herein (e.g., telecommunications infrastructure 100), according to some embodiments. Client device 210 (e.g., at least one of devices 110) and server 230 (e.g., hosting services and applications 140) are communicatively coupled over network 150 (e.g., connection point 120) via respective communications modules 218-1 and 218-2 (hereinafter, collectively referred to as “communications modules 218”). Communications modules 218 are configured to interface with network 150 to send and receive information, such as requests, uploads, messages, and commands to other devices on the network 150. Communications modules 218 can be, for example, modems or Ethernet cards, and may include radio hardware and software for wireless communications (e.g., via electromagnetic radiation, such as radiofrequency -RF-, near field communications -NFC-, Wi-Fi, and Bluetooth radio technology).

Client device 210 may be coupled with an input device 214 and with an output device 216. A user may interact with client device 210 via the input device 214 and the output device 216. Input device 214 may include a mouse, a keyboard, a pointer, a touchscreen, a microphone, a joystick, a virtual joystick, a touch-screen display that a user may use to interact with client device 210, or the like. In some embodiments, input device 214 may include cameras, microphones, and sensors, such as touch sensors, acoustic sensors, inertial motion units -IMUs- and other sensors configured to provide input data to a secondary device. Output device 216 may be a screen display, a touchscreen, a speaker, and the like.

Client device 210 may also include a processor 212-1, configured to execute instructions stored in a memory 220-1, and to cause client device 210 to perform at least some operations in methods consistent with the present disclosure. Memory 220-1 may further include an application 222, configured to run in client device 210 and couple with input device 214 and output device 216. The application 222 may include specific instructions which, when executed by processor 212-1, cause operations to be performed according to methods described herein. Application 222 may receive data from the server 230 and may be hosted by the server 230. In some embodiments, the application 222 runs on an operating system (OS) installed in client device 210. In some embodiments, application 222 may run out of a web browser. In some embodiments, the processor is configured to control a graphical user interface (GUI) for the user of one of client devices 210 accessing the server 230.

A database 252 may store data and files associated with the client device 210 and/or server 230. In some embodiments, client device 210 is a mobile phone used to initiate communication to another client device or server 230. Related data of the communication may be stored at the database 252.

Server 230 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes an automation platform 232. The automation platform 232 may be configured to perform operations and methods according to aspects of embodiments. The automation platform 232 may share or provide features and resources with the client device, including multiple tools associated with the transfer or receipt of communications with automation platform 232 (e.g., application 222). The administrator may interact with automation platform 232 through application 222, installed in a memory 220-1 of client device 210. Accordingly, application 222 may comprise a user portal or the like. The application 222 may be installed from server 230 and perform scripts and other routines provided by server 230 through any one or more of multiple tools. Execution of application 222 may be controlled by processor 212-1.

The automation platform 232 may be accessible to users as a service. The automation platform 232 may be a cloud-based platform. The automation platform 232 may comprise an intent-driven, domain specific, RAN automation platform configured to orchestrate and manage RAN deployments, including network planning, configuration, and optimization, implementing a security approach described according to one or more embodiments. The automation platform 232 may include or be communicatively coupled to middleware facilitating a layered framework for enforcing security in a network (e.g., RAN and/or ORAN). The middleware may operate according to deterministic scheduling, running tasks and processes at specific, predefined times and within designated spaces (hereafter referred to as “space-time”).

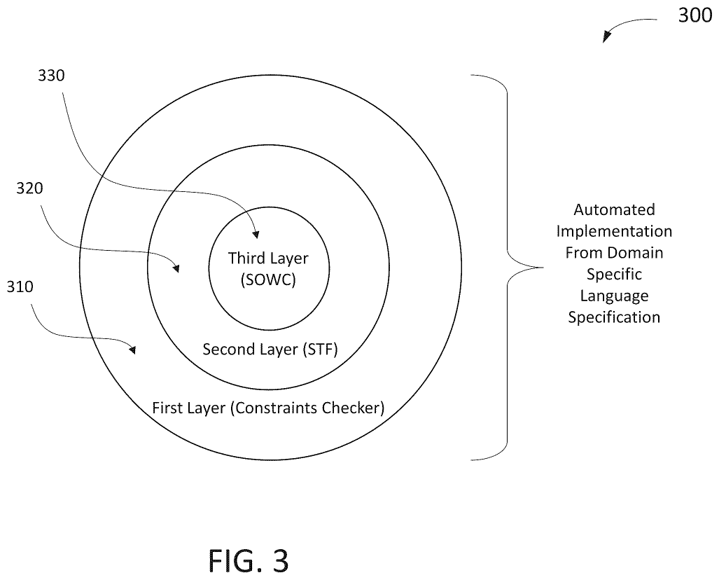

FIG. 3 is an example illustration of middleware 300 employing the layered security framework in a system, according to aspects of one or more embodiments. According to embodiments, the middleware 300 may be a highly secured middleware kernel used to test code for a deployment. The middleware 300 may use DSL to enhance security in RAN. Each layer of the middleware 300 may implement varying levels of security, and target different operations and/or aspects of a deployment, network, etc.

As shown in FIG. 3, the middleware 300 may be divided into three layers: a first layer 310, a second layer 320, and a third layer 330. Embodiments are not limited to this and may include additional layers, one or more of the described layers, and/or various combinations thereof. According to embodiments, the layers of security may be implemented with the most secure and trusted code in the center and the least in the outer layers. According to embodiments, the layered approach enables the system to operate in a deterministic manner where tasks are run at deterministic places in space and time.

The first layer 310 gates input packets to the second layer 320. The first layer 310 may function as a constraints checker, designed to prevent vulnerabilities by ensuring that the system adheres to predefined constraints. The constraints may be set by an administrator, user, or the like. The choice of constraints in, e.g., RAN design may depend on the specific requirements and objectives of the network (e.g., coverage, capacity, quality of service, and energy efficiency). The first layer 310 may consider factors including, but not limited to, hardware limitations, regulatory requirements, and user demands, when performing constraints security checks.

According to embodiments, the first layer 310 checks the validity of the data. By non-limiting example, the first layer 310 may check the protocol syntax and report a parsed message to the second layer 320. Data may flow through the first layer 310 and, if the data passes the constraint checks of the first layer 310 (i.e., input packets are valid), the data may advance to the second layer 320. In some implementations, a RAN deployment may only use a small subset of its capability. If a RAN solution is developed for a large set of possible deployments, then it must parse the possible protocol messages that do not align with the requirements of the deployment. The constraints checker of the first layer 310 may operate at runtime to reject protocol patterns that lie outside of the deployment constraints before they are processed by lower layers in the system (e.g., second layer 320 and third layer 330). This constraints checker may leverage the constrained deployment requirements used to configure the lower two layers of the middleware 300.

The second layer 320 is a collection of stateless functions that process messages from the first layer 310 and enforce certain functions on the system. The second layer 320 may be a Stateless Triggered Function (STF) layer. The stateless functions may be controlled by the state machine of the third layer 330. The third layer 330 may include a data management layer which enables the execution of the stateless functions in one of a finite number of ways. Each of these ways of processing data is defined before runtime from the RAN DSL definition of the functionality of the system.

By non-limiting example, if the system has five cores available for processing, but user-defined constraint specifies that only four cores should be utilized, the STF layer will identify the additional core as a potential vulnerability. Automating these operations in the second layer 320 helps to mitigate risks by reducing the attack surface of the RAN for the deployment.

The third layer 330 may be a Static Optimized Worse Case (SOWC) data management state machine. In some embodiments, the third layer 330 makes up the strongest layer of security in the middleware 300. The SOWC may use system constraints to minimize the complexity of the state machine while forcing a static state machine solution. The SOWC state machine may be developed from a domain-specific language-based specification using automation and constrained optimization. The domain-specific feature of the RAN is leveraged to produce a more secure system in the third layer 330. According to embodiments, the middleware 300 may include a parser co-designed for the SOWC data management flow. The parser may be configured to perform pre-verification of runtime data transformations for security.

According to embodiments, computation in the second layer 320 sits outside of the third layer 330 as an STF layer that has no impact on the SOWC of the third layer 330. In some embodiments, the SOWC includes buffers. In some embodiments, a function in the STF layer may only access a specific set of data buffers. Only the contents of the buffers in the SOWC may be impacted by the STF of the second layer 320. That is, the control and decision-making process of the underlying layers are not impacted by the STF.

According to embodiments, the second layer 320 operates only as allowed by the third layer 330 (e.g., the STF layer operates as a slave to the SOWC layer). The second layer 320 may be configured to execute according to a configuration file provided by the third layer 330. The configuration file may define unit function runs and identify resources required to run the unit function (e.g., how long a unit function, task, and/or code runs and what resources it uses). The functions may be constrained to start after a specific time and end before another specific time (i.e., constrained in “space-time”). This space-time constraint prevents compute operations from starting early, potentially processing data from another user or another system state.

According to embodiments, the configuration file is maintained independently from other data/files of the middleware 300. The second layer 320 may detect misbehavior in the unit function in space-time based on the configuration file provided by the third layer 330. By non-limiting example, misbehavior in unit functions may include functions running for too long, attempting to write into invalid memory space, unexpected density of data access (e.g., the number of times a load/store opcode is used is higher or lower than expected), arriving at a particular program counter (PC) value more or fewer times than expected, completing too quickly or too slowly, or exiting the function at an unexpected PC value.

According to embodiments, unit functions may not run outside of a fixed schedule detailed in configuration files and opportunistic processing is not allowed. For example, RAN functions can only be run by the STF (second layer 320) while the first layer 310 manages inputs/outputs to the middleware 300 and the third layer holds the state. This prevents potential attacks involving compromised functions in the system that try to use resources with time not allocated to them.

Changes to the functionality of the RAN during continuous integration and continuous deployment (CICD) are brought in from deeper in the network so it is not impacted by invalid input packets. Even if it is corrupted, the configuration files that define the function can only change the operation of the middleware 300 in the second layer 320 data space, which is stateless, and are eventually time limited in their impact. A corrupted configuration file will likely lead to an invalid flow because unit functions will not have the data available in time for them to process and will raise timing error flags (which does not happen in opportunistic processing). Therefore, the configuration will be seen by the system as clearly defective and can efficiently be replaced. This could happen in general systems as an invalid input packet could be used to modify the behavior of the flow by delaying the start or end of an element in that flow. Because flows are not separated from the unit functions, a corrupted unit function can change the flow, potentially adding a new function to the flow running in data space. The security structure of the middleware 300 is oblivious to the data, and therefore the flow cannot change due to corrupted functions.

In some embodiments, all data flows that the middleware 300 runs may have a finite time span. As such, the middleware 300 is configured to eventually terminate the function and its output cannot impact the operation of the middleware 300. The termination time for functions may be controlled based on the configuration file defined in third layer 330. Functions may be executed in the second layer 320 according to the termination times detailed in the configuration file. The functions may modify at least one memory buffer of the middleware 300 in the data space. Therefore, any invalid data will stay in the designated space and can be checked at the end of the flow, ensuring that functions can only modify data within the designated data space and preventing invalid data from corrupting other functions or data spaces. Such data checking may include protocol encryption, such that that even a MITM attack will not penetrate the functioning of the RAN itself, even if it successfully penetrates the user data. By non-limiting example, data may be validated at the end of a slot of uplink processing before being used further. This prevents hackers from running unauthorized code in the system by limiting their ability to execute only within specific, predefined times and within designated spaces.

According to some embodiments, if a task fails to complete within a window prescribed by the third layer 330, the task is forcibly terminated and rewound so that it has no impact on the state. An output corresponding to the failed task may be marked “empty,” and the data management state machine of the third layer 330 may move forward independently of this result. As a result of this, timing anomalies due to attempted attacks on the system are suppressed at the SOWC/STF boundary, preventing attacks from reaching the center. The independent connection of the STF elements to the SOWC limits attack propagation opportunities. In some implementations, users can leverage this by maintaining the most secure and trusted code within the third layer 330 for maximum security protection.

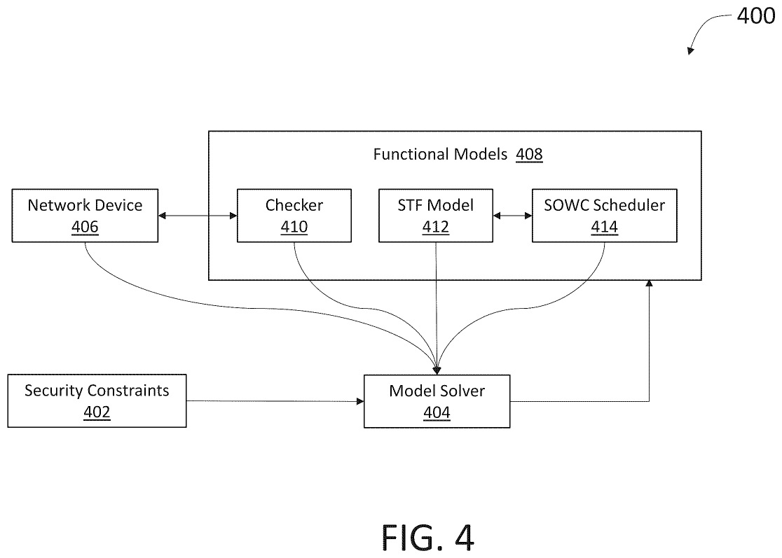

FIG. 4 is an exemplary block diagram modelling a checking process 400 in a modem architecture in a communication network, according to aspects of one or more embodiments. The checking process 400 may include security constraints 402, model solver 404, network device 406, and functional models 408 including functional blocks implementing a layered security framework.

Security constraints 402 may represent the constraints or security requirements desired for a network including one or more deployment devices. A user may define and input one or more security constraints of the network (e.g., in a RAN deployment, or the like) into security constraints 402. The security constraints define how the network should behave, including but not limited to rules for how and when devices or code should run, and how data should move through the network.

According to embodiments, security constraints 402 may include functions that are added to the system at certain points to make it more secure. For example, security constraints may be protocol checkers that are not part of an ORAN flow but are used to deflect MITM attacks. As another example, the security constraints may be functions of the mean and standard deviation of a particular signal to ensure it remains within an expected range. As another example, the security constraints may include security function features such as testing signals against expectations (e.g., ranges). Such security function features are not a direct part of the RAN functionality but may be added to the RAN functionality along with reporting mechanisms by way of the checking process 400. Security constraints 402 may be expressed as mathematical expressions, functions, linear inequalities (e.g., maximum transmit power, minimum signal-to-noise ratio), equalities (e.g., resource allocation balance), or the like. RANs may also be constrained by hardware abstractions that define logical descriptions of how hardware components behave.

According to some embodiments, security constraints may be described in a programmable language (e.g., RDSL) and implemented in a RAN. The user may input security constraints and parameters as a natural language description of a desired deployment. Security constraints 402 may be configured to generate RAN programmable language defining the constraints/parameters of the desired RAN based on the input.

The network device 406 may comprise one or more potentially compromised devices or equipment in a network. In some embodiments, the network device 406 may correspond to, for example, a radio unit (RU), distributed unit (DU), centralized unit (CU), baseband unit (BBU), and/or network interface card (NIC), in a RAN. By non-limiting example, an RU may be compromised based on packets received from the RU at a DU being compromised. malicious actors may attempt to use the compromised RU to gain unauthorized access to the RAN. According to embodiments, the network device 406 is in a static state wherein the network configuration and operational parameters of the device remain fixed and operate according to predefined settings without dynamic adjustments or changes.

The security constraints 402 may be input to a model solver 404. The model solver 402 may be configured to run a solve to define space-time boundaries based on the input security constraints 402. Running the solve results in functional models 408 with designed space time constraints to perform checking processes to ensure the security constraints 402 are not violated. According to embodiments, the functional models 408 may include code that is implemented on the network device 408. The functional models 408 may describe a checking process according to the layered security framework (e.g., of middleware 300). According to embodiments, the functional models 408 may include a checker 410, an STF model 412, and a SOWC scheduler 414. Each of the functional models 408 may have a statically assigned place in space and time (i.e., state space) for operating.

The checker 410 may be configured to perform a protocol check, operating as a constraints checker for incoming data packets from the network device 406. By non-limiting example, the checker 410 may correspond to a first layer of security for the system and perform operations corresponding to the first layer 310. By non-limiting example, the incoming packets may include RU eCPRI packets used to interface between an RU and a DU in Open RAN architectures. In some embodiments, the checker 410 may be configured to determine if the incoming data packets are valid based on security constraints 402. In response to determining that the incoming packets are invalid, the data may be locked in the designed state space. Given the static nature of the constraints checker, invalid data packets may be dealt with without impact to another state space. In response to determining that the incoming packets are valid, the incoming data may be processed by STF model 412 (e.g., within the next layer of security). As such, only valid data is enabled access and processed in the functional layer of the middleware 300.

The STF model 412 may be configured to execute stateless triggered functionality based on data packet termination. According to embodiments, all operations must be performed within a defined time window (e.g., start at a specified start time and stop when a termination time is reached). By non-limiting example, the STF model 412 may correspond to a second layer of security for the system and perform operations corresponding to the second layer 320. The STF model 412 may operate based on the needs for termination of a communication protocol (e.g., eCPRI protocol) defined by the SOWC scheduler 414 in the modem state machine. The SOWC scheduler 414 may maintain configuration files that use system constraints to minimize the complexity of the state machine while forcing a static state machine solution.

The model solver 404 may be configured to analyze the security constraints 402 which define how the network device 406 should operate. In some embodiments, the model solver 404 receives one or more constraints from security constraints 402 and creates the functional models 408 based therefrom. The functional models 408 may be deployed on the network device 406. Results of the functional models 408 (i.e., the checking process) may continuously be input to the model solver 404 and used by the model solver 404 to update/modify aspects of the functional models 408, refining configurations for the network device 406 running the functional models 408. The model solver 404 may implement AI reasoning to identify constraints, patterns, and/or boundaries of the network based on said inputs. By non-limiting example, the model solver 404 may reason about boundaries for data usage limits, memory access, data movement patterns, etc., and generate one or more boundaries or additional constraints for the system (e.g., one or more devices in a RAN).

In some implementations, one of the functional models 408 may identify a violation in the system necessitating a new security component. The new security component may result in new security constraints and will trigger a rerun of the model solver 404. In some implementations, rerunning the model solver 404 may result in creation of new functional model to perform additional checking in real time based on the new security constraints introduced due to the new security component. The model solver 404 is configured to ensure that any new security components behave correctly within the set of constraints on the system (e.g., security constraints 402, the new security constraints, and knowledge of the network).

In some embodiments, based on the model solver's knowledge of the network, the security constraints 402 may be analyzed to identify security issues in the network device 406. Knowledge of the modem architecture may include, but is not limited to, RAN topology, network infrastructure, hardware specifications, deployment configurations, functional architecture, operational characteristics of the RAN, or the like. In response to a security issue being identified, the model solver 404 may be configured to determine which of the functional models 408 require modifications. The model solver 404 may provide updates to one or more of the functional models 408 based on the determination until all security issues are resolved in the network device 406.

According to embodiments, the analysis of the model solver 404 may include using artificial intelligence (AI) and/or machine learning (ML) techniques to decide which of the functional blocks, if any, need modifying to most efficiently remove any identified security issues. In some embodiments, the model solver's analysis of the network may result in a static, optimized worse case solution for the network device 406 based on, for example, the security constraints 402, new constraints identified by the model solver 404, and/or functional models 408. In some embodiments, the security issues may be identified as violations of the model checking process, with examples of the security violation given as counter examples in the model solver 404.

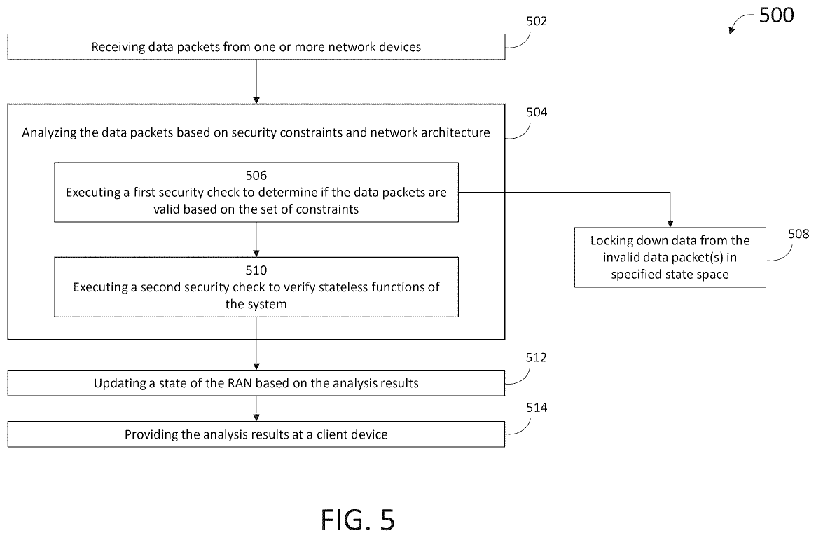

FIG. 5 illustrates an example flow diagram (e.g., process 500) for implementing layered security in a RAN deployment, according to certain aspects of the disclosure. Further for explanatory purposes, the steps of the example process 500 are described herein as occurring in serial, or linearly. However, multiple instances of the example process 500 may occur in parallel. Operations described with reference to FIG. 5 may correspond to implementation of functional models (e.g., functional models 408) deployed to ensure that a system stays within its designated space-time.

At step 502, the process 500 may include receiving data packets from one or more network devices associated with a RAN. The one or more devices may include, but are not limited to, RUs, DUs, CUs, switches, or the like. Data packets may include, but are not limited to, data flows or code to be run in the RAN deployment. In some embodiments, the process 500 may further include receiving one or more security constraints from a network administrator or user responsible for configuring network devices.

At step 504, the process 500 may include continuously analyzing the data packets based on a set of security constraints and the RAN architecture to identify potential security issues. The analysis may be based on a layered security framework (e.g., of middleware 300 and/or deployed as functional models 408). Based on the set of security constraints and the RAN architecture, the designed security framework may include one or more security mechanisms (i.e., first and second security check).

At step 506, the process 500 may include executing a first security check in a first layer of the security framework in the system. The first security check may include a constraints checker configured to determine if the data packets are valid based on a set of constraints. This layer of security prevents attacks from penetrating the functioning of the device itself, even if it successfully penetrates the data packets. In some embodiments, the set of constraints may be assigned to the one or more devices in a RAN deployment. The first security check may be designed to check constraints of the system against the data packets. By non-limiting example, the constraints checker may observe arriving data packets for patterns, timing, behaviors, data points, program code, or the like, that lie outside of deployment constraints before they are processed by lower security layers in the system.

If the data packets fail one or more checks, the data packets are identified as invalid and the process 500 proceeds to step 508. If the data packets pass the checks, the data packets are identified as valid and the process 500 proceeds to step 510. In some implementations, failing over a threshold number of checks (e.g., a percentage of checks) may result in the data packet being identified as invalid. In some implementations, some combination of checks failing may automatically result in the data packed being identified as invalid. Embodiments of the present disclosure are not intended to be limited to any percentage or number of constraint checks. It will be understood and appreciated by those having ordinary skill in the art that the metric for determining validity of a data packet is configurable and may include any desired threshold.

According to some embodiments, the first security check may be performed within a specific state space. Meaning, the operations of the functional decoder or constraints checker are stateless and execute at specified times, for defined durations, and within a specified space. The first security check may implement a domain-specific approach (e.g., using DSL) to ensure that the devices are operating as instructed/desired. Therefore, any input data that lies outside of those bounds will be locked down in the specified state space. Accordingly, invalid data packets may be dealt with in the specific state space without impacting another state space. This domain-specific feature of the RAN is exploited to produce a more secure system in the first layer of security in the system.

At step 508, in response to the data packets being identified as invalid, data from the invalid data packet(s) may be locked down in the specified state space of the first layer. This limits any potential attempts to compromise the system in the first layer by isolating invalid (e.g., potentially compromised) data to the specific state space. In some implementations, in response to the data packet being invalid, the system may reject the data packet, allowing the system to continue operating as if the packet was never received. Accordingly, bad actors are unable to store data or program code outside of the specified state space (e.g., privilege space, such as in the operating system), which may then be triggered to compromise the system.

At step 508, the process 500 may include executing a second security check in a second layer of the security framework in the system to verify stateless functions of the system. The second security check may be configured to execute stateless functions of the RAN using the validated data packets and verify the stateless functions of the network based on a data management state machine. According to embodiments, in response to the data packet being valid (at step 506), the data packets may proceed or gain access to another designated space-time that is specifically allocated for executing the second security check in the second layer. The one or more device's functionality may be primarily contained in the second layer.

According to embodiments, the process 500 may include receiving configuration files from another designated space allocated for a third layer of the security framework in the system. The designated space may be independent and distinct from each of the security layers (i.e., first, second, and third layers). According to embodiments, the second layer may be statically scheduled to space-time according to the configuration files maintained by the third layer. The configuration files may define hardware and/or software functionality including, but not limited to, how long unit functions run, what resources they may use, and where unit functions run. Accordingly, even if a bad actor manages to get past the first layer and drops suspicious data or program code in the system, any attempts to activate the suspicious data or program code will be ignored because only preset functions are allowed to run at certain space-times (e.g., times within certain locations in memory in the system).

According to embodiments, the second security check may be in an STF computation layer configured to detect misbehavior in unit functions in space-time based on a configuration file defined by an SOWC data management state machine. According to some embodiments, the STF layer operates only when configuration information becomes available from the SOWC data management state machine. This constraint prevents the compute operation in the second layer from starting early, potentially processing data from another user or another system state. According to some embodiments, the process 500 may include identifying functions details, including a termination time from the SOWC data management state machine. The STF computation layer may receive the functions details from the SOWC and execute unit functions accordingly.

At step 512, the process 500 may include updating a state of the RAN based on the analysis results from step 504. In some implementations, if all the data in the system is determined to be valid or safe at each security check, the state of the system may be updated based on the valid interactions. In some implementations, if any of the checks in process 500 identify issues in the system, the state of the system may be updated accordingly. By non-limiting example, in response to detecting misbehavior in unit functions (at step 510), the state space designated for the second security check may be sanitized before proceeding to a next processing state. In some embodiments, the process 500 may further include detecting misbehavior in a unit function in the second data space and sanitizing the second data space for traces of compromised data processed by the unit function. By non-limiting example, a processor executing the second security check may be shut down and its cached memory wiped to remove any trace of the compromised data, updating a current state without impacting other states or aspects of the system.

At step 514, the process 500 may include providing the analysis results to a client device (e.g., operated by an administrator of the network). In some embodiments, step 514 may include reporting statistics on potentially malicious data (identified and locked in steps 506 and 508, respectively) or functionality in the one or more network devices (identified in step 510). Accordingly, the network device is continuously analyzed and if a violation is identified, the state may be updated accordingly and an administrator notified of the violation.

According to embodiments, the process 500 may further include identifying potentially malicious data or functionality in one or more network devices as part of the analysis results (e.g., at step 504), reporting statistics on the potentially malicious data or functionality to the administrator (e.g., at step 512), and generating one or more solutions for the network in response to identifying the potentially malicious data or functionality. In some embodiments, the process 500 may further include providing the one or more solutions to the administrator (e.g., at step 512). According to embodiments, the analysis results may include security issues identified in the system. The security issues may be identified as violations to the security checks deployed in the process 500. In some embodiments, the process 500 may further include providing examples of the security violations to the administrator (e.g., at step 512).

In some embodiments, the analysis may leverage an AI reasoning platform to identify constraints, patterns, and/or boundaries of the network. According to some embodiments, the analysis may be used to generate solutions for the network including, but not limited to, updated boundaries for data usage limits, memory access, data movement patterns, or the like. In some embodiments, the process 500 may include generating one or more boundaries or additional constraints for the network based on the analysis. In some embodiments, the process 500 may include modifying one or more of the security checks based on the analysis (e.g., adding a new rule or security constraint to the system). According to embodiments, any implementation of new security components identified by the analysis in step 504 would trigger a rerun of a solve for the system (e.g., model solver 404).

It is understood that the described systems and methods may be applied to any real-time system (RTS), and not just to RANs. The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

### Hardware Overview

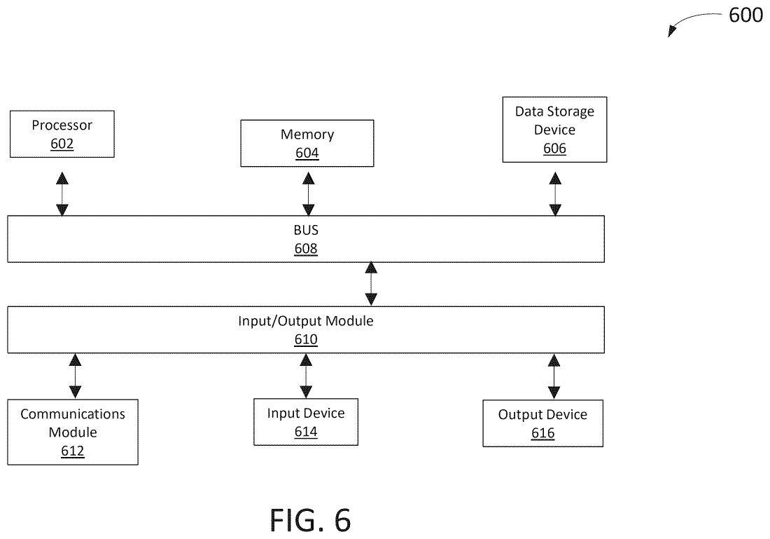

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities. Computer system 600 (e.g., server and/or client) includes a bus 608 or other communication mechanism for communicating information, and a processor 602 coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor, for displaying information to the user.

According to one aspect of the present disclosure, the above-described systems can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in the main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads and processes data, information may be read from the data and stored in a memory device, such as the memory 604. Additionally, data from the memory 604 servers accessed via a network, the bus 608, or the data storage 606 may be read and loaded into the memory 604. Although data is described as being found in the memory 604, it will be understood that data does not have to be stored in the memory 604 and may be stored in other memory accessible to the processor 602 or distributed among several media, such as the data storage 606.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed:

1. A computer-implemented method for implementing security in a network development, comprising:
receiving data packets from one or more network devices in a radio access network (RAN);
analyzing the data packets based on a set of constraints and functions of the RAN, the analysis including:
validating, in a first data space, the data packets based on a set of constraints;
executing, in a second data space, stateless functions of the RAN using the validated data packets based on configuration files; and
updating a state of the RAN based on results of the analyzing.

2. The computer-implemented method of claim 1, wherein validating the data packets further comprises:
determining that at least a portion of the data packets are invalid; and
locking the invalid portion of the data packets in the first data space.

3. The computer-implemented method of claim 1, wherein validating the data packets further comprises:
determining that at least a portion of the data packets are valid; and
enabling access to the second data space to perform unit functions with the valid data packets.

4. The computer-implemented method of claim 1, wherein the stateless functions are executed in one of a finite number of ways for a finite time span as defined in the configuration files.

5. The computer-implemented method of claim 1, wherein the configuration files are maintained by a state machine in a third data space independently from other data stored by middleware associated with the RAN.

6. The computer-implemented method of claim 5, wherein the state machine is developed from a domain-specific language-based specification.

7. The computer-implemented method of claim 1, further comprising:
determining that the execution of at least one of the stateless functions fails to complete within a termination time window included in the configuration files; and
terminating the at least one of the stateless functions, wherein an output of a failed stateless function is marked empty.

8. The computer-implemented method of claim 1, further comprising:
detecting misbehavior in a unit function in the second data space; and
sanitizing the second data space for traces of compromised data processed by the unit function.

9. The computer-implemented method of claim 1, wherein the updating is based on an analysis recognizing a violation based on the set of constraints.

10. A system for security in a network development, comprising:
a processor; and
a memory comprising instructions stored thereon, which when executed by the processor, causes the processor to perform:
receiving data packets from one or more network devices in a radio access network (RAN);
analyzing the data packets based on a set of constraints and functions of the RAN, the analysis including:
validating, in a first data space, the data packets based on a set of constraints;
executing, in a second data space, stateless functions of the RAN using the validated data packets based on configuration files; and
updating a state of the RAN based on results of the analyzing.

11. The system of claim 10, further comprising stored sequences of instructions, which when executed by the processor, cause the processor to perform:
determining that at least a portion of the data packets are invalid; and
locking the invalid portion of the data packets in the first data space.

12. The system of claim 10, further comprising stored sequences of instructions, which when executed by the processor, cause the processor to perform:
determining that at least a portion of the data packets are valid; and
enabling access to the second data space to perform unit functions with the valid data packets.

13. The system of claim 10, wherein the stateless functions are executed in one of a finite number of ways for a finite time span as defined in the configuration files.

14. The system of claim 10, wherein the configuration files are maintained by a state machine in a third data space independently from other data stored by middleware associated with the RAN.

15. The system of claim 14, wherein the state machine is developed from a domain-specific language-based specification.

16. The system of claim 10, further comprising stored sequences of instructions, which when executed by the processor, cause the processor to perform:
determining that the execution of at least one of the stateless functions fails to complete within a termination time window included in the configuration files; and
terminating the at least one of the stateless functions, wherein an output of a failed stateless function is marked empty.

17. The system of claim 10, further comprising stored sequences of instructions, which when executed by the processor, cause the processor to perform:
detecting misbehavior in a unit function in the second data space; and
sanitizing the second data space for traces of compromised data processed by the unit function.

18. The system of claim 10, wherein the updating is based on an analysis recognizing a violation based on the set of constraints.

19. A non-transitory computer-readable storage medium comprising instructions stored thereon, which when executed by one or more processors, cause the one or more processors to perform operations for implementing security in a network development, the operations comprising:
receiving data packets from one or more network devices in a radio access network (RAN);
analyzing the data packets based on a set of constraints and functions of the RAN, the analysis including:
validating, in a first data space, the data packets based on a set of desired constraints;
executing, in a second data space, stateless functions of the RAN using the validated data packets based on configuration files; and
updating a state of the RAN based on results of the analyzing, wherein the configuration files are maintained independently from other data stored by middleware associated with the RAN and provided to the second data space by a state machine in a third data space.

20. The non-transitory computer-readable storage medium of claim 19, wherein the stateless functions are executed in one of a finite number of ways for a finite time span as defined in the configuration files.
